(19) United States
(12) Patent Application Publication
(10) Pub. No.: US 2007/0078840 A1
(43) Pub. Date: Apr. 5, 2007

(54) Custom function library for inverse query evaluation of messages

(75) Inventors: Aaron A. Stern, Bellevue, WA (US); Geary L. Eppley, Carnation, WA (US); Umesh Madan, Bellevue, WA (US)

Correspondence Address: Rick Nydegger;Workman Nydegger, 1000 Eagle Gate Tower, 60 East South Temple, Salt Lake City, UT, 84111, US

(73) Assignee: Microsoft Corporation, Redmond, WA (US)

(21) Appl. No.: 11/244,947

(22) Filed: Oct. 5, 2005

(51) Int. Cl. G06F 17/30

(52) U.S. Cl. 707/4

(57) ABSTRACT

In an inverse query environment, exemplary embodiments describe a set of shortcut keys that can be used to augment common query functions making it easier for developers to write query expressions. Further, these shortcut keys can be used to more efficiently execute equivalent functionality of the common query expressions, without evaluating large query strings against the message. In addition, embodiments described herein allow for automatic versioning of query functions, allowing for more maintainability of query expression sets. For example, a custom query library is provided with information about standard query functions based on industry wisdom of those functions most commonly referenced and/or versioned. Developers can use abbreviated query function shortcut keys in executing equivalent functionality of the lengthier string values for common query functions. The custom query library can also be modified with up-to-date information as industry changes are needed, thereby automatically maintaining the query expressions.

### CROSS-REFERENCE TO RELATED APPLICATIONS

N/A

### BACKGROUND

Background and Relevant Art

Computing systems—i.e. devices capable of processing electronic data such as computers, telephones, Personal Digital Assistants (PDA), etc.—communicate with other computing systems by exchanging data messages according to a communications protocol that is recognizable by the systems. Such a system utilizes filter engines containing queries that are used to analyze messages that are sent and/or received by the system and to determine if and how the messages will be processed further.

A filter engine may also be called an “inverse query engine.” Unlike a database, wherein an input query is tried against a collection of data records, an inverse query engine tries an input against a collection of queries. Each query includes one or more conditions, criteria, or rules that must be satisfied by an input for the query to evaluate to true against the input.

For example, an XPath filter engine is a type of inverse query engine in which the filters are defined using the XPath language. The message bus filter engine matches filters against eXtensible Markup Language (XML) to evaluate which filters return true, and which return false. In one conventional implementation, the XML input may be a Simple Object Access Protocol (SOAP) envelope or other XML document received over a network.

A collection of queries usually takes the form of a tree like data structure, where each node in the tree represents an instruction and each path executed from a root node to a terminating branch node represents a query expression. Each data structure may include hundreds or thousands of query expressions, and each query path may contain several conditions, criteria, or rules (herein referred to as “criteria”). As such, each query path may be seen as a series of instructions that include various functions, language constructs, and/or operations as defined by the inverse query specifications. As messages are received, their inputs are converted into a form conducive to the inverse query engine, which then evaluates the inputs against the instruction paths for each of the query expression.

Developers write query expressions to search and find those messages of interest based on their specific needs and implementations. For example, developers typically write expressions for identifying messages with certain IDs, from specific clients/servers, which meet their security, reliability, and other policy criteria. Accordingly, a developer will write alphanumeric text strings that represent specific instructions or functions for identifying message of interest. As changes occur in the industry, a good developer adapts to the changes by including those updates into their code. For example, as new versions of message encapsulation (e.g., SOAP versions 1.1 and 1.2) and/or new query functions are made available, the developer should update their software for accommodating these changes, while still supporting legacy systems. Writing expressions themselves, however, can be quite tricky leading to developer annoyance, let alone having to continually update expressions based on all the changes in the industry. Further, these updates produce query context strings that can become very large and are prone to error.

In addition, each query expression or function typically includes a namespace and local name for addressing purposes. Typically, a namespace manager must be created for handling each namespace in the expression, which are listed as some long URLs for referencing and defining the appropriate standard to use for the particular function. As such, a developer not only needs to remember these lengthy URLS, but also needs to appropriately list them, again leading to developer frustration and/or errors within the query context string values.

### BRIEF SUMMARY

The above-identified deficiencies and drawback of current inverse query systems are overcome through example embodiments of the present invention. For example, embodiments described herein provide for a custom query library that allows a developer a convenient and efficient mechanism for executing the functionality of common query functions, while also support ease in maintenance of the common query functions. Note that this Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One example embodiment provides a developer of query expressions with a convenient and efficient mechanism for executing the functionality of common query functions, while maintaining up-to-date versioning thereof. In this embodiment, a query expression is received with criteria to be compared against inputs of messages received at an inverse query filter engine. Thereafter, instructions of the query expression are executed for determining if the messages match the criteria thereof. The instruction(s) are then identified as including a query function shortcut key used by a developer in executing equivalent functionality of a standard query function without requiring the developer to write an expanded query string value for the standard query function. Further, a custom function library is also accessed that includes information about the standard query function based on industry wisdom of those functions most commonly referenced and/or versioned. Finally, the query function shortcut key is matched with the information about the standard query function in order to execute the equivalent functionality for determining if the messages match the criteria thereof.

Another example embodiment provides maintenance to query expressions by modifying information about common query functions within a custom query library. In this embodiment, an update for a standard query function is received whose equivalent functionality can be executed using a query function shortcut key within a query expression, which is applied against messages to determine if they meet the criteria thereof. A custom query library is then accessed that includes information about the standard query function based on industry wisdom of those functions most commonly referenced and/or versioned. The information about the standard query function is then modified with the information about the update in order to automatically maintenance the query expression that includes the query function shortcut key, without requiring a developer to include an expanded string value for the updated standard query function.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an inverse query engine configured to process standard queries using query function shortcut keys in accordance with example embodiments of the present invention;

FIG. 2 illustrates a flow diagram of a method of providing a developer with a convenient and efficient mechanism for executing the functionality of common query functions in accordance with example embodiments; and

FIG. 3 illustrates a flow diagram for a method of providing maintenance to query expression in accordance with example embodiments.

### DETAILED DESCRIPTION

The present invention extends to methods, systems, and computer program products for executing and maintaining common query functions using a query function shortcut key. The embodiments of the present invention may comprise a special purpose or general-purpose computer including various computer hardware or modules, as discussed in greater detail below.

As can be appreciated, query expressions (e.g., XPath expressions) designed to extract small pieces of messages (e.g., SOAP messages) can be tricky and complex, especially as new versions of either the functions or encapsulation protocols for a message evolve. Accordingly, exemplary embodiments describe a set of shortcut keys that can be used to augment standard query functions making it easier for developers to write query expressions. Further, these shortcut keys can be used to more efficiently execute equivalent functionality of the common query expressions, without evaluating large query strings against the message. In addition, embodiments described herein allow for automatic versioning of query functions, allowing for more maintainability of query expression sets.

More specifically, exemplary embodiments provide for a custom function or query library with information about common or standard query functions based on industry wisdom of those functions most commonly referenced and/or versioned. Developers can use abbreviated query function shortcut keys to execute equivalent functionality of the corresponding lengthier string values for the common query functions. These query function shortcut keys not only allow the developer a more concise way to reference standard functions, but also allow a filter engine to more efficiently execute the functions. For example, rather then using a long expanded string value for comparison against inputs of a message, the present invention allows for the automatic execution of code to retrieve input information automatically and return the results to the query engine for further processing. In addition, as new updates or versions of the function and/or encapsulation for the messages are discovered, these updates can be applied to query function shortcut keys by simply updating the custom function library.

Although more specific reference to advantageous features are described in greater detail below with regards to the Figures, embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

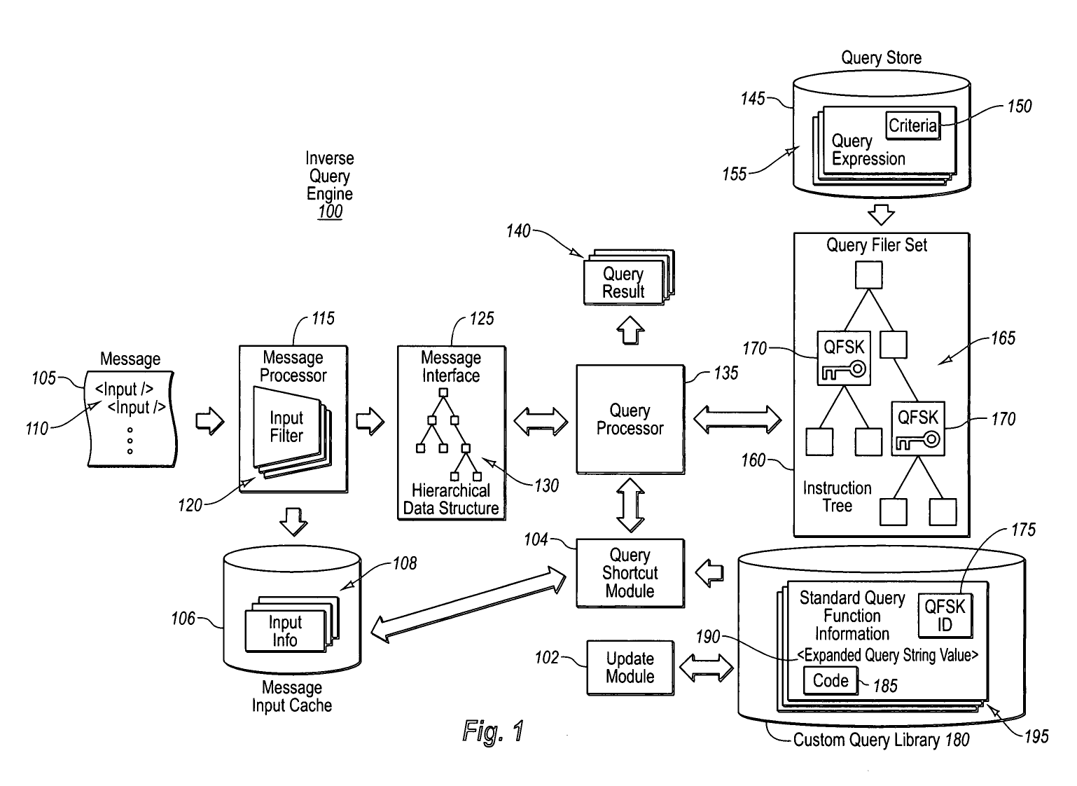

FIG. 1 illustrates a inverse query engine 100 configured to process standard query functions, or the equivalent functionality thereof, using query function shortcut keys (QFSKs) in accordance with exemplary embodiments. As shown in FIG. 1, a message 105 may be received with various inputs 110 to the inverse query engine 100. The message 105 may be received over a communication channel, or it may be accessed from memory, storage, or received from any number of input components. In accordance with one embodiment, the electronic message 105 is a hierarchically-structured document such as an eXtensible Markup Language (XML) document or a Simple Object Access Protocol (SOAP) envelope.

Once received, the message may be passed to a message processor 115, which includes various input filters 120. These input filters 120 may be used to generate input information 108 that can be temporarily stored in message input cache 106. Typically, the input information 108 will be information about the message inputs 110 most commonly referenced by the inverse query engine 100 and other applications as needed. For example, the input information 108 may include a message ID, the version of encapsulation (e.g., SOAP 1.1 and/or 1.2), who the message is from, where the message is destined to, security features of the message 105, etc. As will be described in greater detail below, this input information 108 can be used to execute equivalent functionality of standard query functions in accordance with exemplary embodiments. Nevertheless, note that the types of input info 108 listed above are not meant to be an extensive list of commonly reference data. Accordingly, the use of any specific reference to a particular type of input info 108 is for illustrative purposes only and is not meant to limit or otherwise narrow embodiments as described herein.

Regardless of the type of input info 108 filtered from the message 105, a message interface 125 can be used to expose the message inputs 110 in a hierarchical data structure 130. Note that although the hierarchical data structure 130 is shown as a tree like structure, any type of hierarchical data structures is available (e.g., an array of XML data). As such, the hierarchical data structure 130 as shown is used for illustrative purposes only and is not meant to limit or otherwise narrow the scope of the embodiments described herein. Nevertheless, the hierarchical data structure 130 may be used by query processor 135 for evaluation against the query filter set 160 for determining if the inputs 110 match the criteria 150 for the query expressions 155.

More specifically, the query expressions 155 and their criteria 150 can be accessed from query store 145 and passed to query filter set 160. The query filter set 160 can then combine the query expressions 155 into a hierarchical data structure (e.g., instruction tree 165) such that each node within the instruction tree 165 represents an instruction for the criteria 150 and each path extending from a root node to a terminating node represents a full query expression 155. The instruction tree 165 may then be used for evaluating against the inputs 110 of messages received in order to determine which, if any, of the criteria 150 they meet.

Typically, when creating the query expressions 155, a developer will write the criteria using an alphanumeric string values that includes such information as a namespace, local name, and instructions used in evaluation of various versions of a particular message. For example, if the function is an XPath function for returning a node set containing just a header node, the developer may use the following pseudo code string value within his XPath function:
(/S11:Envelope/S11:header|/S12:Envelope/S12:header) [1],
wherein S11 and S12 represent different versions of SOAP messages.

Example embodiments as described herein, however, provide for query function shortcut keys (QFSKs) 170, which allow a developer to reference equivalent functionality of standard query functions without requiring the developer to write a complete query string values thereof. For instance, rather than writing the full string value in the example above, a developer may simply reference function using the QFSK 170, e.g., “header( )”. (Note that although the QFSK 170 is shown within the instruction tree 165, the text string used will typically reside in the query expression before compilation into the instruction tree 165. Nevertheless, the QFSK 170 is shown within the instruction tree 165 for ease in describing example embodiments herein.)

As will be described in greater detail below, query function shortcut key QFSKs 170 represent concise string value used in referencing the functionality of a larger standard query functions. Accordingly, when the query processor 135 identifies query function shortcut key 170 during evaluation, the query processor 135 can prompt the query shortcut module 104 to return the appropriate equivalent functionality. More specifically, when prompted query shortcut module 104 can access the custom query library 180 and identify the standard query function information 195 corresponding to the QFSK 170. For example, the query shortcut module 104 may use the QFSK ID 175 that maps to particular standard query function information 195. Note, however, that any other way of referencing data is also contemplated in accordance with example embodiments described herein. In any event, this standard query function information 195 can then be used to identify equivalent functionality of a standard query function.

Note that the custom query library 180 is populated with information 195 for functions most commonly referenced and/or versioned based on industry wisdom. Nevertheless, this information 195 may be adjusted based on industry changes. For example, as the industry evolves, the custom query library 180 may be extended or portions thereof removed based on the wisdom gained from experts and customer feedback. In fact, as will be described in greater detail below, the custom query library offers a layer of abstraction between the QFSK 170 and details of the information 195, which allows for updates and maintenance as needed without the change in the QFSK 170. Accordingly, the use herein of any specific type of standard query function information 195 is for illustrative purposes only and is not meant to limit or otherwise narrow the scope of the present invention unless explicitly claimed.

Regardless of the type of function referenced in the standard query function information 195, the present invention contemplates various ways of providing the equivalent functionality for the standard query function. For example, as shown in FIG. 1, upon identifying the appropriate information 195 for the QFSK 170, the equivalent functionality may be in the form of the expanded query string value 190. In particular, the expanded query string value 190 would be the string that the developer would use in describing the standard function within the query expression, which is then passed to the query processor 135 for normal processing. In other words, the use of the QFSK 170 to access expanded query string value 190 can be thought of as a macro process of expanding an abbreviated version of data into a larger string. This larger string, i.e., the expanded query string value 190, can then replace the QFSK 170 value for a string comparison against the inputs 110 to produce query results 140 (i.e., determine if message meets the criteria 150 for the particular standard query function).

In contrast, another example embodiment provides for a more efficient way of executing the equivalent functionality of the standard query functions 195 through the use of code 185 within the information 195. In this embodiment, query shortcut module 104 can execute a block of code 185 to access message input cache 106 and the input information 108 therein. If the message input cache 106 includes input information 108 corresponding to the standard query function, query shortcut module 104 can pass such results directly to the query processor 135. Note that this process produces the same equivalent functionality as using the expanded query string value 190, but without the need to iterate over the inputs 110 and do string comparisons thereof. Accordingly, this embodiment provides for a more efficient processing since the results can be produced at a much faster rate. Nevertheless, if the required input info is not available, the system 100 may default back to using the expanded query sting value 190.

Other embodiments allow the custom query library 180 to be maintained based on upon updated versioning and other industry change. Accordingly, as shown in FIG. 1, an update module 102 may be provided for use in accessing the standard query function information 195 within the custom query library 180. Modifications may then be made by adding, deleting, or otherwise changing the information 195 within the custom query library 180. Note that in this embodiment, either the expanded query string value 190 and/or the object code 185 can be updated, which are then used to produce query results 140 as previously described.

Also note that this modification of the standard function information 195 will automatically update the QFSK 170, without requiring the developer to modify existing query expressions 155 and/or to expand the query context strings of subsequent query expressions 155. In other words, the developer can continue to use the query function shortcut key 170 with confidence in knowing that previous query expressions 155 will automatically be updated and subsequent query expressions 155 will also be up-to-date with the latest versioning of message encapsulation and/or query functionality.

Note that in another example embodiment, namespace prefixes are defined by default such that the QFSK 170 may include only a local name (e.g., header or body), rather than a qualified or Qname (i.e., namespace prefix and local name). For example, in the case above for the “header ( )” QFSK 170, normally the namespace prefix would appear as follows: “sm:header ( )”. Nevertheless, embodiments provided herein provide for a default namespace prefix that automatically maps to the standard query function for the QFSK 170. In other words, a developer does not need to create a namespace manager and provide the lengthy URLs or URIs for these common namespace prefixes. For example, below is a list of four XML, SOAP, and XPath namespace prefix mappings that may be used in conjunction with embodiments described herein. Note, however, that the present invention also contemplates other namespace prefixes as they apply to the corresponding standard query functions. Accordingly, the following list of default namespace prefixes is provided herein for illustrative purposes only and is not meant to limit or otherwise narrow the scope of the present invention.

| | |
|---|---|
| s11 | http://schemas.xmlsoap.org/soap/envelope/ |
| s12 | http://www.w3.org/2003/05/soap-envelope |
| wsa | http://schemas.xmlsoap.org/ws/2003/03/addressing |
| sm | http://schemas.microsoft.com/serviceModel/2004/05/xpathfunctions |

To give more concrete examples of query function shortcut keys 170, default use of namespace prefixes, and other embodiments that may be used for referencing equivalent functionality herein described, below is a table of XPath context strings, their corresponding equivalent functionality, and a text sting that may represent an XPath QFSK 170. Note, however, the XPath QFSK 170 provided may be modified or appear as some other sting value. Also note that as the XPath representations change (e.g., as new versions occur), the expanded XPath context strings may also change. Further note, that this table is not intended to be a complete representation of all available standard query functions, but as described previously the list is subject to change based upon continued learned wisdom within the industry.

| XPath Shortcut | Equivalent | |
|---|---|---|
| Key | Functionality | Expanded XPath Context String |
| header ( ) | Returns a node set | (/s11:Envelope/s11:Header \| |
| | containing just the | /s12:Envelope/s12:Header)[1] |
| | header node. | |
| body ( ) | Returns a node set | (/s11:Envelope/s11:Body \| |
| | containing just the | /s12:Envelope/s12:Body)[1] |
| | body node. | |
| soap-uri ( ) | Returns the string | namespace-uri(/s11:Envelope \| |
| | value of the soap | /s12:Envelope) |
| | namespace of the | |
| | message. | |
| headers-with-actor | Returns a node set | /s11:Envelope/s11:Header/*[@s11:actor |
| (string) | containing all | =$string] \| |
| | header nodes with | s12:Envelope/s12:Header/*[@s12:role= |
| | the specified | $string] |
| | role/actor. | |
| actor (node-set) | Returns the string | string( |
| | value of the | $node- |
| | role/actor attribute | set[1][/s11:Envelope]/@s11:actor \| |
| | of the first node in | $node- |
| | the node set. | set[1][/s12:Envelope]/@s12:role |
| | | ) |
| is-mandatory | Returns the | $node- |
| (node-set) | Boolean value of | set[1][/s11:Envelope]/@s11:mustUnderstand |
| | the | =“1” or |
| | “mustUnderstand” | $node- |
| | attribute of the | set[1][/s12:Envelope]/@s12:mustUnderstand |
| | first node in the | =“true” |
| | node set. | |
| is-actor-next (node- | Returns true/false | (/s11:Envelope and sm:actor($node-set) |
| set) | depending on | = |
| | whether the | “http://schemas.xmlsoap.org/soap/actor/ |
| | role/actor attribute | next”) |
| | of the first node in | or |
| | the node set is the | (/s12:Envelope and sm:actor($node-set) |
| | “next” value. | = |
| | | “http://www.w3.org/2003/05/soap- |
| | | envelope/role/next”) |
| is-actor-ultimate- | Returns the | (/s11:Envelope and sm:actor($node-set) |
| receiver (node-set) | true/false | = “”) |
| | depending on | or |
| | whether the | (/s12:Envelope and sm:actor($node-set) |
| | role/actor attribute | = “http://www.w3.org/2003/05/soap- |
| | of the first node in | envelope/role/ultimateReceiver”) |
| | the node set is the | |
| | “ultimate receiver” | |
| | value. | |
| messageId ( ) | Returns the string | string((sm:header( |
| | value of the ws- | )/wsa:MessageID/text( ))[1]) |
| | Addressing | |
| | MessageId header | |
| | (string). | |
| relates To ( ) | Returns the ws- | sm:header( )/wsa:RelatesTo |
| | Addressing | |
| | RelatesTo headers | |
| | (node-set) | |
| replyTo ( ) | Returns the ws- | (sm:header( )/wsa:ReplyTo)[1] |
| | Addressing | |
| | ReplyTo header | |
| | (node-set) | |
| From ( ) | Returns the ws- | (sm:header( )/wsa:From)[1] |
| | Addressing From | |
| | header (node-set) | |
| faultTo ( ) | Returns the ws- | (sm:header( )/wsa:FaultTo)[1] |
| | Addressing | |
| | RelatesTo header | |
| | (node-set) | |
| to ( ) | Returns the string | string(sm:header( )/wsa:To) |
| | value of the ws- | |
| | Addressing To | |
| | header (string). | |
| action ( ) | Returns string | string((sm:header( )/wsa:Action/text( |
| | containing the | ))[1]) |
| | string value of the | |
| | ws-Addressing | |
| | Action header | |
| | (string). | |
| recipient( ) | Returns the ws- | (sm:header( )/wsa:Recipient)[1] |
| | Addressing | |
| | recipient header | |
| | (node-set) | |

In other embodiments, there may be defined QFSK 170 for custom equivalent functionality that currently does not have an expanded query string value 190. For example, the following provides some examples of XPath QFSKs that currently have no query string representation. Note, however, that the list is used for illustrative purposes only and is not meant to limit or otherwise narrow the scope of the embodiment herein described.

| | | Expanded XPath |
|---|---|---|
| XPath Shortcut Key | Equivalent Functionality | Context String |
| date-time(string) | Returns the decimal days in | None |
| | UTC since midnight, Jan. 1, | |
| | 1C.E. that the argument string | |
| | represents. | |
| duration(string) | Returns the decimal days that | None |
| | the argument string represents | |
| utc-now( ) | Returns the decimal days in | None |
| | UTC since midnight, Jan. 1, | |
| | 1C.E. | |

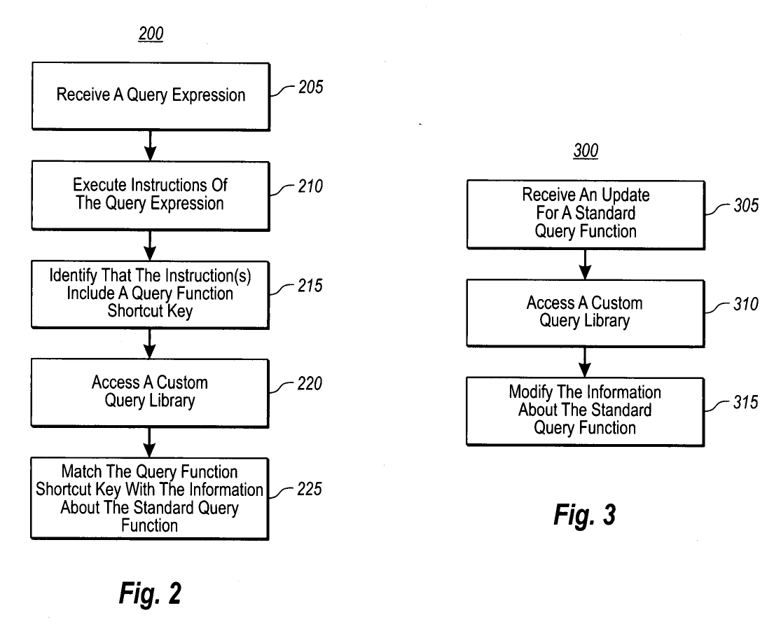

The present invention may also be described in terms of methods comprising functional steps and/or non-functional acts. The following is a description of steps and/or acts that may be performed in practicing the present invention. Usually, functional steps describe the invention in terms of results that are accomplished, whereas non-functional acts describe more specific actions for achieving a particular result. Although the functional steps and/or non-functional acts may be described or claimed in a particular order, the present invention is not necessarily limited to any particular ordering or combination of steps and/or acts. Further, the use of steps and/or acts is the recitation of the claims—and in the following description of the flow diagrams for FIGS. 2 and 3—is used to indicate the desired specific use of such terms.

As previously mentioned, FIGS. 2 and 3 illustrate flow diagrams for various exemplary embodiments of the present invention. The following description of FIGS. 2 and 3 will occasionally refer to corresponding elements from FIG. 1. Although reference may be made to specific elements from FIG. 1, such references are used for illustrative purposes only and are not meant to limit or otherwise narrow the scope of the described embodiments unless explicitly claimed.

FIG. 2 illustrates a method 200 of providing a query expression developer with a convenient and efficient mechanism for executing equivalent functionality of common query functions, while maintaining up-to-date versioning thereof. Method 200 may include an act of receiving 205 a query expression. For example, the inverse query engine 100 may receive a message that includes various inputs 110 to be compared against criteria 150 of query expressions 155. The message may be an XML document, e.g., a SOAP message.

Method 200 also includes an act for executing 210 instructions of the query expressions. For example, the inverse query engine 100 can execute instructions of the query expressions 155 to create the hierarchal instruction tree 165 within in the query filter set 160. As will be appreciated, the instruction tree 165 and instructions therein will be used for determining if messages match the criteria 150 thereof.

Method 200 also includes an act for identifying 215 that the instruction(s) include a query function shortcut key. For example, query processor 135, or other processor, may identify that the instruction 170 includes a query function shortcut key 170 used by a developer in executing equivalent functionality of a standard query function without requiring the developer to write a complete expanded query string value 190 for the standard query function. Note that the equivalent functionality may include the expanded query string value 190, or may be a block of code 185 used by query shortcut module 104 to directly produce query results 140.

Method 200 also includes an act for accessing 220 a custom query library. For example, query shortcut module 104 can be used to access custom query library 180 that includes information about the standard query function 195 based on industry wisdom of those functions most commonly referenced and/or versioned. Note that the custom query library 180 may also provide for a namespace default binding mechanism such that no namespace declaration is needed for the QFSK 170.

Thereafter, method 200 includes an act for matching 225 the query function shortcut key with the information about the standard query function. More specifically, query shortcut module 104 can match the query function shortcut key 170 with the standard query function information 195 in order to execute the equivalent functionality for determining if the messages match the criteria thereof. The execution of the equivalent functionality may include macro functionality of returning the expanded query string value 190 for comparison against the inputs 110 for the message 105. Alternatively, the execution of the equivalent functionality may automatically determine a query result 140 for the standard query function without macro functionality of returning the expanded query string value 190. Further note, the equivalent functionality may include functionality for a combination of one or more functions, operations, or language constructs.

As will be noted in greater detail below, the custom query library 180 may be maintained with up-to-date information about common query functions based on changes in the industry wisdom. For example, the information about the standard query function 195 may be replaced with new information for executing equivalent functionality corresponding to a different query function shortcut key of a different standard query function based on the changes in the industry wisdom.

Also note that the query expressions 125 may be XPath expressions, and the equivalent functionality may include one or more of: returning a node set containing a header node; returning a node set containing a body node; returning a string value of SOAP namespace of a message; returning a node set containing header nodes with the specified roles/actor; returning the string value of role or actor attribute of the first node in a node set; returning a boolean value of the mustUnderstand attribute of a first node in a node set; returning true or false depending upon whether a role or actor attribute of a first node in a node set is the “next” value; returning true or false depending upon whether a role or actor attribute of the first node in a node set is the “ultimate receiver” value; returning the string value of a ws-Addressing Message ID header string; returning a ws-Addressing “relates To” header node-set; returning a ws-Addressing “reply To” header node-set; returning a ws-Addressing “From” header node-set, etc.

FIG. 3 illustrates a method 300 of providing maintenance to query expression by modifying information about common query functions within a custom query library. Method 300 includes an act for receiving 305 an update for a standard query function. For example, update module 102 may receive an update for a standard query function whose equivalent functionality can be executed using a query function shortcut key 170 within a query expression 155, which is applied against message to determine if they meet the criteria thereof. Method 300 also includes an act for accessing 310 a custom query library. More specifically, update module 102 may access custom query library 180 that includes information about the standard query function based on industry wisdom of those functions most commonly referenced and/or versioned.

Method 300 further includes an act for modifying 315 the information about the standard query function. For example, update module 102 can be used for modifying the information about the standard query function 195 with information about the update in order to automatically maintenance the query expression 155 that includes the query function shortcut key 170, without requiring a developer to include an expanded string value for the updated standard query function. Note that the custom query library 180 also provides for a namespace default binding mechanism such that no namespace declaration is needed for the query function shortcut key 170, and the update may include an update to the default namespace. Further, the update may include modifying the information about the standard query function 195 with a new version of a protocol for the messages. For example, the new version of the protocol may be a SOAP versioning.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. In an inverse query filter engine used in evaluating inputs of messages against a plurality of query expressions, a method of providing a query expression developer with a convenient and efficient mechanism for executing equivalent functionality of common query functions, while maintaining up-to-date versioning thereof, the method comprising:
receiving a query expression with criteria to be compared against inputs of messages received at an inverse query filter engine;
executing instructions of the query expressions for determining if the messages match the criteria thereof;
identifying that one or more of the instructions include a query function shortcut key used by a developer in executing equivalent functionality of a standard query function without requiring the developer to write an expanded query string value for the standard query function;
accessing a custom query library that includes information about the standard query function based on industry wisdom of those functions most commonly referenced/used, versioned, or both; and
matching the query function shortcut key with the information about the standard query function in order to execute the equivalent functionality for determining if the messages match the criteria thereof.

2. The method of claim 1, wherein the custom query library also provides for a namespace default binding mechanism such that no namespace declaration is needed for the query function shortcut key.

3. The method of claim 1, wherein the execution of the equivalent functionality includes macro functionality of returning the expanded query string value for comparison against the inputs of the messages.

4. The method of claim 1, wherein the execution of the equivalent functionality automatically determines a query result for the standard query function without macro functionality of returning the expanded query string value.

5. The method of claim 1, wherein the custom query library is maintained with up-to-date information about common query functions based on changes in the industry wisdom.

6. The method of claim 5, wherein the information about the standard query function is replaced with new information for executing equivalent functionality corresponding to a different query function shortcut key of a different standard query function based on the changes in the industry wisdom.

7. The method of claim 1, wherein the equivalent functionality includes functionality for a combination of one or more functions, operations, or language constructs.

8. The method of claim 1, wherein the messages are SOAP messages and wherein the information about the standard query function includes information for executing the equivalent functionality that supports multiple SOAP versions.

9. The method of claim 8, wherein the query expressions are XPath expressions, and wherein the equivalent functionality includes one or more of: returning a node set containing a header node; returning a node set containing a body node; returning a string value of SOAP namespace of a message; returning a node set containing header nodes with the specified roles/actor; returning the string value of role or actor attribute of the first node in a node set; or returning a boolean value of the mustUnderstand attribute of a first node in a node set.

10. A computer program product that includes computer readable media having stored thereon computer executable instructions that, when executed by a processor, can cause the inverse query engine to perform the method of claim 1.

11. In an inverse query filter engine used in evaluating inputs of messages against query expressions, a method of providing maintenance to the query expressions by modifying information about common query functions within a custom query library, the method comprising:
receiving an update for a standard query function whose equivalent functionality can be executed using a query function shortcut key within a query expression, which is applied against messages to determine if they meet the criteria thereof;
accessing a custom query library that includes information about the standard query function based on industry wisdom of those functions most commonly referenced, versioned, or both; and
modifying the information about the standard query function with information about the update in order to automatically maintenance the query expression that includes the query function shortcut key, without requiring a developer to include an expanded string value for the updated standard query function.

12. The method of claim 11, wherein the custom query library also provides for a namespace default binding mechanism such that no namespace declaration is needed for the query function shortcut key.

13. The method of claim 12, wherein the update includes an update to the default namespace.

14. The method of claim 11, wherein the update includes modifying the information about the standard query function with a new version of a protocol for the messages.

15. The method of claim 14, wherein the new version of the protocol is a SOAP versioning.

16. The method of claim 11, wherein the execution of the equivalent functionality includes macro functionality of returning the expanded query string value for comparison against the inputs of the messages.

17. The method of claim 11, wherein the execution of the equivalent functionality automatically determines a query result for the standard query function without macro functionality of returning the expanded query string value.

18. The method of claim 11, wherein the equivalent functionality includes functionality for a combination of one or more functions, operations, or language constructs.

19. The method of claim 11, wherein the query expression is an XPath expressions, and wherein the equivalent functionality includes one of: returning true or false depending upon whether a role or actor attribute of a first node in a node set is the “next” value; returning true or false depending upon whether a role or actor attribute of the first node in a node set is the “ultimate receiver” value; returning the string value of a ws-Addressing Message ID header string; returning a ws-Addressing “relates To” header node-set; returning a ws-Addressing “reply To” header node-set; or returning a ws-Addressing “From” header node-set.

20. A computer program product that includes computer readable media having stored thereon computer executable instructions that, when executed by a processor, can cause the inverse query engine to perform the method of claim 11.
